(19) United States
(12) Patent Application Publication
(10) Pub. No.: US 2020/0393554 A1
(43) Pub. Date: Dec. 17, 2020

(54) METHOD AND APPARATUS FOR SEGMENTED MOTION SENSING

(71) Applicant: GuRu, Inc., Pasadena, CA (US)

(72) Inventors: Amirreza Safaripour, Pasadena, CA (US); Seyed Ali Hajimiri, Pasadena, CA (US); Behrooz Abiri, Pasadena, CA (US)

(21) Appl. No.: 16/844,871

(22) Filed: Apr. 9, 2020

Related U.S. Application Data
(60) Provisional application No. 62/832,208, filed on Apr. 10, 2019.

(51) Int. Cl. G01S 13/62

(52) U.S. Cl. CPC G01S 13/62

(57) ABSTRACT

A Doppler sensing system includes, in part, at least one transmit antenna, a processor configured to cause the transmit antenna to transmit signals during M repeating cycles of a sequence, and a receiver configured to receive reflections of the signals generated by the transmit antenna. For each cycle, the transmit antenna is set to N different transmit settings each during a different one of N time periods to generate N different signals. The sequence may be uniform or non-uniform. The N time periods may be substantially similar. The transmitter may be set at least twice to at least one of the N settings during each cycle. The receiver optionally includes, in part, a first frequency downconverter adapted to generate in-phase (I) signals and a second frequency downconverter adapted to generate quadrature-phase (Q) signals. The processor generates the I and Q signals from the signals the processor receives from the receiver.

### CROSS REFERENCE TO RELATED APPLICATIONS

The present application claims benefit under 35 USC 119 (e) of U.S. provisional Application No. 62/832,208, filed Apr. 10, 2019, entitled “Segmented Motion Sensing”, the content of which is incorporated herein by reference in its entirety.

### FIELD OF THE INVENTION

The present invention relates to motion detection.

### BACKGROUND OF THE INVENTION

The ability to detect the rate of movements of objects within a limited range of distances benefits a variety of applications such as gaming, security, health systems, wireless power transfer systems, communication systems, and the like. Doppler sensing has been traditionally used for this purpose where a signal is transmitted and reflected off a moving target. The shift in the frequency of the reflected signal relative that of the transmitted signal (i.e., the Doppler frequency shift caused by the moving target) is proportional to the velocity of the moving target. The Doppler frequency shift may be down-converted and monitored by a receiver for a time duration. The duration of the sampling and detection of this signal determines the accuracy with which the Doppler shift is measured. Therefore, for objects moving relatively slowly thus causing relatively small Doppler frequency shift, the sensing system requires a relatively long time to monitor the reflected signal and reliably capture the small rate of movement.

Reliable detection of slow movement is important in systems such as wireless power delivery systems in order to satisfy the regulatory and exposure limit requirements in the presence of humans. For example, detecting the presence of humans in the vicinity and/or in the path of the power transfer by capturing their slow movements or by identifying the signature of the movements associated with vital activities, such as respiration and heartbeat, enables compliance with such regulations.

The ability to detect the presence and velocity of a moving object and living organism is even more essential indoors where the transmit signal may propagate through multiple paths due to multiple reflections and scatterings. Conventional Doppler sensing systems require a relatively long time to detect relatively small Doppler frequency shifts.

### BRIEF SUMMARY OF THE INVENTION

A Doppler sensing system, in accordance with one embodiment of the present invention, includes, in part, at least one transmit antenna, a processor configured to cause the transmit antenna to transmit signals during M repeating cycles of a sequence, and a receiver configured to receive reflections of the signals generated by the transmit antenna. For each cycle, the transmit antenna is set to N different transmit settings each during a different one of N time periods to generate N different signals. The sequence may be a uniform or a non-uniform sequence.

In one embodiment, the signal transmitted during cycle i of the sequence is received by the receiver during cycle i of the sequence. In one embodiment, the N time periods are substantially similar. In one embodiment, at least one of the N time periods is different than the remaining time periods. In one embodiment, the transmitter is set at least twice to at least one of the N settings during each cycle.

In one embodiment, the receiver includes, in part, a first frequency downconverter adapted to generate in-phase (I) signals and a second frequency downconverter adapted to generate quadrature-phase (Q) signals. In one embodiment, the processor is further configured to generate the I and Q signals associated with each transmit setting from the signals the processor receives from the receiver.

In one embodiment, the Doppler sensing system further includes, in part, a phase switching circuit adapted to switch a phase of a local oscillator (LO) signal by 90° in responses to a phase control signal supplied by the processor, and a frequency downconverter adapted to generate in-phase (I) and quadrature-phase (Q) signals from the signal received by the receiver and in response to the phases of the LO signal.

In one embodiment, the Doppler sensing system further includes, in part, a phase switching circuit adapted to switch the phase of a transmit signal by ±90° in responses to a phase control signal supplied by the processor. The processor causes the transmitter to transmit, for each transmit setting, a first signal defined by a first phase, and a second signal defined by a second phase. The sequence may include uniform and non-uniform cycles. In one embodiment, the processor causes the Doppler sensing system to transfer power wirelessly during at least one of the N periods.

A method of determining a frequency shift of a signal reflected by a moving object, in accordance with one embodiment of the present invention, includes, in part, transmitting signals during M repeating cycles of a sequence, where for each cycle a transmit antenna is set to N different transmit settings during each of N different time periods to generate N different signals, and receiving reflections of the signals generated by the transmit antenna to determine the frequency shift. The sequence may be a uniform or a non-uniform sequence.

In one embodiment, the method further includes, in part, receiving, during cycle i of the sequence, a signal transmitted during cycle i of the sequence. In one embodiment, the N time periods are substantially similar. In one embodiment, at least one of the N time periods is different than the remaining time periods. In one embodiment, the transmitter is set at least twice to at least one of the N settings during each cycle.

In one embodiment, the method further includes, in part, down-converting the frequency of the received signal to generate an in-phase (I) signal using a first frequency down-converter, and down-converting a frequency of the received signal to generate a quadrature-phase (Q) signal using a second frequency down-converter. In one embodiment, the method further includes, in part, down-converting the frequency of the received signal to generate in-phase (I) and quadrature-phase (Q) signals using a frequency down-converter.

In one embodiment, the method further includes, in part, switching a phase of a local oscillator (LO) signal by ±90° in responses to a phase control signal supplied by a processor, and generating in-phase (I) and quadrature-phase (Q) signals from the received signal in response to the phases of the LO signal. In one embodiment, the method further includes, in part, switching the phase of a transmit signal by ±90° in responses to a phase control signal supplied by a processor, and transmitting, for each transmit setting, a first signal defined by a first phase and a second signal defined by a second phase. In one embodiment, the sequence includes, in part, uniform and non-uniform cycles. In one embodiment, the method further includes, in part, transferring power by the transmitter wirelessly during at least one of the N periods.

### BRIEF DESCRIPTION OF THE DRAWINGS

FIGS. 1A, 1B and 1C show exemplary transmit paths associated with three different transmit settings of a Doppler sensing system in a two-dimensional space.

FIGS. 2A, 2B and 2C show moving objects within confines of a region in which signals shown in FIGS. 1A, 1B and 1C are transmitted.

FIG. 3 is a simplified high-level schematic block diagram of a receiver disposed in Doppler sensing system, in accordance with one embodiment of the present invention.

FIGS. 4A and 4B are exemplary output signals of a receiver of a Doppler sensing system, in accordance with one embodiment of the present invention.

FIGS. 5A and 5B respectively show the in-phase and quadrature phase signals associated with a first transmit setting of the data shown in FIGS. 4A and 4B, in accordance with one embodiment of the present invention.

FIGS. 6A and 6B respectively show the in-phase and quadrature phase signals associated with a second transmit setting of the data shown in FIGS. 4A and 4B, in accordance with one embodiment of the present invention.

FIGS. 7A and 7B respectively show the in-phase and quadrature phase signals associated with a first transmit setting of the data shown in FIGS. 4A and 4B, in accordance with one embodiment of the present invention.

FIG. 8 is a simplified high-level schematic block diagram of a receiver disposed in Doppler sensing system, in accordance with one embodiment of the present invention.

FIG. 9 shows exemplary in-phase and quadrature phase output signals of a receiver of a Doppler sensing system, in accordance with one embodiment of the present invention.

FIGS. 10A and 10B respectively show the in-phase and quadrature phase signals associated a first transmit setting of the data shown in FIG. 9, in accordance with one embodiment of the present invention.

FIGS. 11A and 11B respectively show the in-phase and quadrature phase signals associated a second transmit setting of the data shown in FIG. 9, in accordance with one embodiment of the present invention.

FIGS. 12A and 12B respectively show the in-phase and quadrature phase signals associated a third transmit setting of the data shown in FIG. 9, in accordance with one embodiment of the present invention.

FIG. 13A is a simplified high-level block diagram of a transmitter/receiver adapted to rapidly switch between transmit settings to provide Doppler sensing and wirelessly power a device, in accordance with one embodiment of the present invention.

FIG. 13B is a simplified high-level block diagram of a transmitter/receiver adapted to rapidly switch between transmit settings to provide Doppler sensing and wirelessly power a device, in accordance with one embodiment of the present invention.

FIG. 14A shows the space, scanned by a Doppler sensing system, being divided into a multitude of sectors, in accordance with one embodiment of the present invention.

FIG. 14B shows a pair of objects moving in a number of sectors shown in FIG. 14A, in accordance with one embodiment of the present invention.

FIGS. 15A and 15B respectively show the in-phase and quadrature phase signals obtained from the sectors shown in FIG. 14B by a Doppler sensing system, in accordance with one embodiment of the present invention.

FIGS. 16A and 16B respectively show the I and Q signals associated with sectors 1, 3, 4, 5, 7 and 8 associated with the data shown in FIGS. 15A and 15B, in accordance with one embodiment of the present invention.

FIGS. 17A and 17B respectively show the I and Q signals associated with the movement of the object in sector number 2 associated with the data shown in FIGS. 15A and 15B, in accordance with one embodiment of the present invention.

FIGS. 18A and 18B shows the i and Q signals associated with the movement of the object in sector number 6 associated with the data shown in FIGS. 15A and 15B, in accordance with one embodiment of the present invention.

FIGS. 19A, 19B and 19C show a Doppler sensing system powering devices wirelessly, in accordance with one embodiment of the present invention.

FIGS. 20A, 20B and 20C show a Doppler sensing system powering devices and detecting movement of objects, in accordance with one embodiment of the present invention.

FIGS. 21A-21J show a Doppler system that switches its transmit settings to one of a multitude of power transfer modes and sensing modes during different times, in accordance with one embodiment of the present invention.

FIG. 22A shows a Doppler system adapted to detect movements using sidelobes while in a power transfer mode, in accordance with one embodiment of the present invention.

FIG. 22B shows the Doppler system of FIG. 22A after being switched into a scanning mode to more accurately determine the movement of the object, in accordance with one embodiment of the present invention.

### DETAILED DESCRIPTION OF THE INVENTION

In accordance with embodiments of the present invention, a fast switching Doppler sensing system (alternatively referred to herein as Doppler sensing system, Doppler system or sensing system) has a substantially enhanced scan time so as to detect relatively slow and small movements of an object, human or living organisms. The Doppler sensing system is further adapted to concurrently detect relatively slow movements at different locations in its vicinity through rapid switching between its multiple transmit settings, without any need to increase the monitor time of the Doppler system's receiver. To achieve this, in one embodiment, the operating parameters (settings) of the transmit elements of a transmitter, or the rotation angle of a mechanically controlled transmitter, are rapidly switched, as described further below.

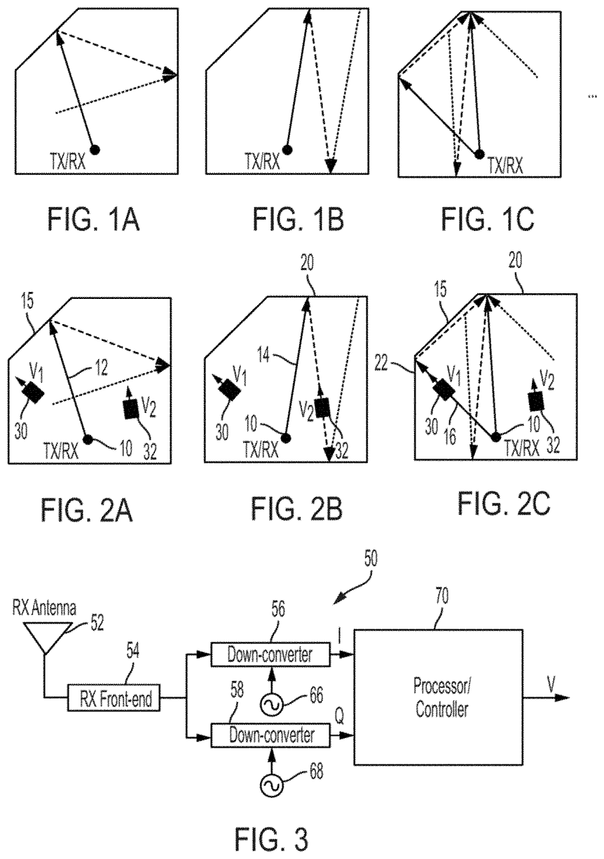

The transmit settings of the Doppler sensing system, in accordance with embodiments of the present invention, are rapidly switched between N different settings. The settings are understood to include phases and/or amplitudes of the various transmit elements of the transmitter array. In one embodiment, each transmit setting is maintained for a period of T seconds and results in an electromagnetic radiation pattern that may include multiple radiation paths due to, for example, possible radiation sidelobes as well as reflections and scattering caused by the environment. FIGS. 1A, 1B and 1C show exemplary transmit paths for three different transmit settings of a Doppler sensing system in a two-dimensional space. As seen from these three Figures, due to the closed confines of the environment, the transmitted waves undergo many reflections.

During each T-second time interval associated with each transmit setting, the Doppler sensing system's receiver captures the signal reflected off the objects located along the transmit path of the Doppler sensing system and provides the down-converted reflected signal at its output. This enables the Doppler sensing systems' receiver to detect during the time interval T to detect movement along the transmit path.

In accordance with one embodiment of the present invention, each of N different combinations of the Doppler system's transmit settings are sequentially applied for a period of T seconds and then repeated for a total sequence period of Ts=NT. Accordingly, for each full cycle of the sequence, the down-converted Doppler system's receiver supplies N signals each associated with a different one of the N transmit settings each of which is T-seconds long. Embodiments of the present invention therefore may be viewed as equivalent to concurrently monitoring the reflected Doppler signal caused by each transmit setting separately and recording samples of it with the sampling rate of fs=1/Ts=1/(NT).

In one embodiment, the time period T, during which the transmit settings is held constant, is selected in accordance with the desired signal to noise ratio at the receiver. In some embodiments, different transmit settings have different time periods. Accordingly, in such embodiments, time period T may vary from one setting to the next. In some embodiments, the sampling duration may be different for different settings, while the rate remains uniform. In some embodiments, one or more of the settings of a sequence may be repeated more frequently than the other settings.

Since the sample duration and sequence of the applied transmit settings are known in advance, the Doppler system's receiver output samples for each transmit setting may be split and separated from the samples associated with other settings. A control/processing unit, which may be an embedded microprocessor, microcontroller, FPGA, ASIC, and the like, may be used to perform the splitting and the separation of the samples.

FIG. 2A shows a Doppler sensing system 10 having a transmitter (TX) and a receiver (RX). The transmitters may include a multitude of transmit elements, and the receiver includes one or more receiving element. The transmitter of Doppler sensing system 10 is assumed to have a first setting thus causing the transmitted signal (beam) to travel along direction 12 before being reflected off wall 15. Also shown in FIG. 2A are two objects 30 and 32 assumed to be moving uniformly receptively with velocities V₁ and V₂ along the directions as shown. As seen from FIG. 2A, beam 12 does not intersect objects 30 and 32.

FIG. 2B shows Doppler sensing system 10 after its transmitter is set to a second setting that is different from the first setting. Beam 14 generated by a Doppler sensing system 10 in accordance with the second setting is shown as being reflected off wall 20 and intersecting object 32. FIG. 2C shows Doppler sensing system 10 after its transmitter is set to a third setting that is different from the first and second settings. Beam 16 generated by system 10 in accordance with the third setting is shown as interesting object 30 and subsequently being reflected off walls 22 and 20.

FIG. 3 is a simplified high-level schematic block diagram of a receiver 50 disposed in Doppler sensing system 10, in accordance with one embodiment of the present invention. Receiver 50 is shown as including, in part, a receive antenna 52, a receive front-end 54, an in-phase frequency downconverter 56 receiving an in-phase local oscillator signal 66, a quadrature frequency downconverter 58 receiving a quadrature local oscillator signal 68, and a processor/controller 70. The signal received by receive antenna 52 is processed (e.g., amplified) by receiver front-end 54 and delivered to down-converteres 56, 56. Frequency down-converter 56 down-converts the frequency of the received signal using local oscillator (LO) signal 66 to generate the in-phase signal I. Similarly, frequency down-converter 58 down-converts the frequency of the received signal using LO signal 68 to generate the quadrature phase signal Q. LO signals 66 and 68 are 90° out of phase with respect to one another. Processor/controller 70 receives signals I and Q, and in response, generates signal V representative of the speed and the direction of the object, such as objects 30 and 32 shown in FIGS. 2A-2C.

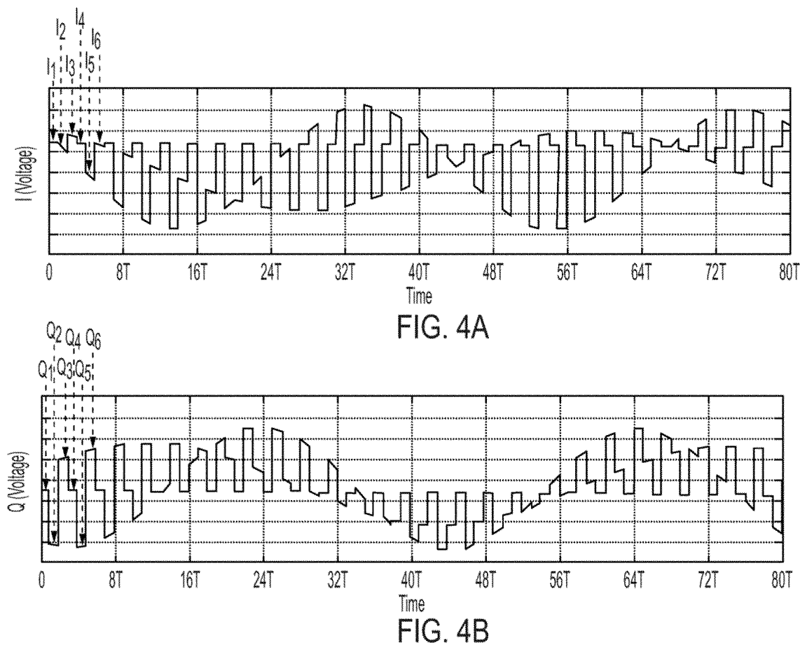

Assume that Doppler sensing system, in accordance with one embodiment of the present invention, uses three different transmitter settings (i.e., N is 3) each of which is applied for the same time period T, as described with reference to FIGS. 2A, 2B and 2C. FIGS. 4A and 4B show signals I and Q of receiver 50 of FIG. 3 for 80 such time periods. Referring to FIG. 4A, the voltage level of signal I as determined during time periods T₁, T₂, T₃m T₄ T₅, T₆ are shown as I₁, I₂, I₃, I₄, I₅, I₆, respectively. Similarly, the voltage level of signal Q as determined during time periods T₁, T₂, T₃, T₄, T₅, T₆ are shown as Q₁, Q₂, Q₃, Q₄, Q₅, Q₆, respectively.

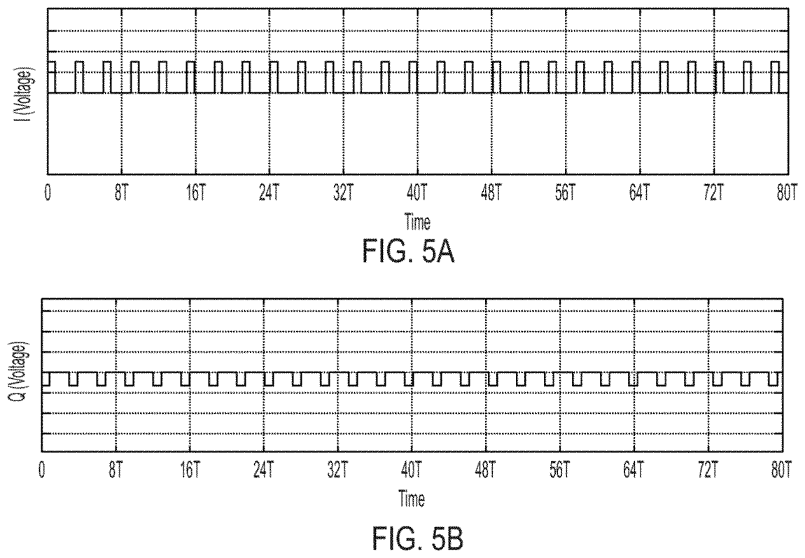

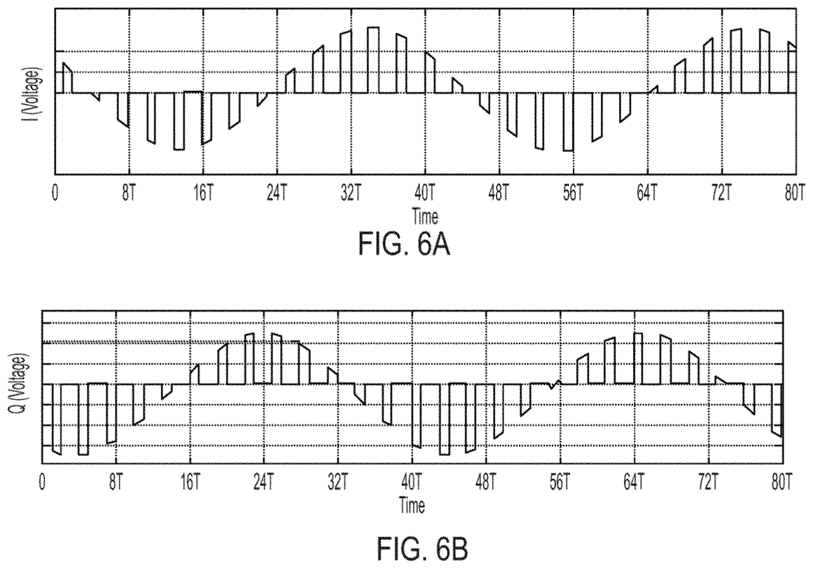

FIGS. 5A and 5B respectively show the I and Q voltages associated with and retrieved from the first transmit setting of the data shown in FIGS. 4A and 4B as determined by processor/controller 70 of FIG. 3. As is seen from FIGS. 5A and 5B, since no moving object is present in the path of the beam generated in response to the first transmit setting, the corresponding I and Q signals for this setting shows that there is no movement along this path, therefore the reflections from stationary objects result in a DC output for both the I and Q signals. FIGS. 6A and 6B respectively show the I and Q voltages associated with and retrieved from the second transmit setting of the data shown in FIGS. 4A and 4B as determined by processor/controller 70 of FIG. 3.

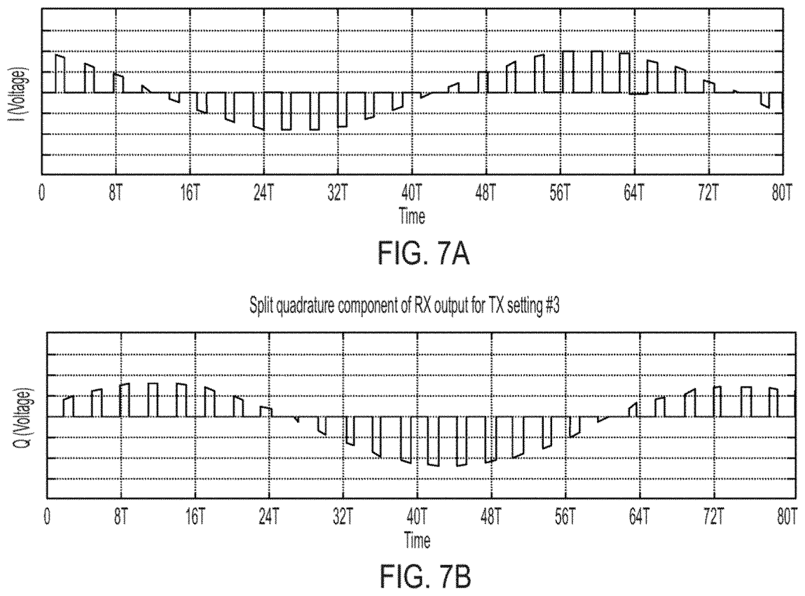

FIGS. 7A and 7B respectively show the I and Q voltages associated with and retrieved from the third transmit setting of the data shown in FIGS. 4A and 4B as determined by processor/controller 70 of FIG. 3. As seen from FIGS. 6A/6B or 7A/7B, the I/Q signals for the second and third transmit settings provide sampled sinusoidal waves with frequencies f_{d1} and f_{d2} indicative of the presence of moving objects with velocities v₁ and v₂ that are proportional to frequencies f₁ and f₂, respectively.

According to the Nyquist sampling theorem, with the effective sampling rate fₛ of signals I/Q for each transmit setting, the maximum detectable Doppler frequency shift, f_{d,max}, associated with each transmit setting that may be recovered from the measured samples without any loss, is:

$${f}_{s} > 2 {f}_{d} \to {f}_{d , max} = \frac{1}{2 NT}$$

As described above, using a uniform switching sequence, each of the transmit settings 1 through N is applied during a different time period T. Sequence (1) shown below is one such sequence, in accordance with one exemplary embodiment of the present invention, in which numbers 1 through N refer to different transmit settings each applied during a different one of time periods T.

1->2->3-> . . . ->N->1->2->3-> . . . ->N-> . . . (1)

Each sequence cycle refers to one complete transition of the full transmit settings. For example, one cycle of sequence (1) is 1->2->3-> . . . ->N. Therefore, in the switching method defined in accordance with expression (1), the reflected signal corresponding to each transmit setting is sampled with the same sampling rate as other settings, as shown below:

$${f}_{s , 1} = {f}_{s .2} = … {f}_{s , N} = \frac{1}{NT} \qquad ( 2 )$$

Assume that a Doppler sensing system, in accordance with embodiments of the present invention, is adapted to switch rapidly between N different transmit settings that are repeated M times (i.e., the sequence is defined by M repeating cycles of N transitions each corresponding to a different one of the N transmit settings). Accordingly, a signal received by the Doppler sensing system using any of the N transmit settings is sampled M times. By processing the M samples for each of the N transmit settings, as described further below, the Doppler sensing system is adapted to accurately and quickly determine the speed and direction of a slow moving object.

In accordance with expression (2), the maximum detectable Doppler frequency shift for all transmit settings are equal and defined by:

$${f}_{d , max , 1} = {f}_{d , max , 2} = … {f}_{d , max , N} = \frac{1}{2 NT} \qquad ( 3 )$$

In accordance with one aspect of the present invention, the switching sequence of transmit settings may be selected so as to increase the sampling rate of the reflected signal. For example, if the reflections associated with the first transmit setting are sampled at a higher rate than other transmit settings, the maximum detectable Doppler shift for the first transmit setting will be higher than those of other settings. For example, assume a non-uniform switching sequence as shown below:

1->2->1->3->1->4 . . . ->1->N->1->2->1>3-> . . . 1->N-> . . . (4)

The non-uniform switching sequence shown in expression (4) increases the sampling rate for the first transmit setting, i.e., f_{s,1}, while reducing the sampling rate f_{s,2}, f_{s,3} . . . f_{s,N} for the other transmit setting settings 2 through N, as shown below:

$$\begin{matrix}{f}_{s , 1} = \frac{1}{2 T} & ( 5 ) \\ {f}_{s , 2} = {f}_{2 , 3} … {f}_{s , N} = \frac{1}{2 ( N - 1 ) T} & ( 6 )\end{matrix}$$

As a result, for N>2, the maximum detectable Doppler frequency shift for transmit setting number 1 (i.e., the first transmit setting) associated with the sequence shown in expression (4) is:

$${f}_{d , max , N} = \frac{1}{4 T} \qquad ( 7 )$$

The maximum detectable Doppler frequency shift for the other transmit settings, i.e., 2 through N associated with the sequence shown in expression (4) is:

$${f}_{d , max , 2} = {f}_{d , max , 3} = … {f}_{d , max , N} = \frac{1}{4 ( N - 1 ) T} \qquad ( 8 )$$

Therefore, in accordance with some embodiments of the present invention, the maximum detectable Doppler frequency shift for transmit setting number 1 associated with the sequence shown in expression (4) and defined in expression (7) is greater than the maximum detectable Doppler frequency shift for transmit setting number 1 associated with the sequence shown in expression (1) and defined in expression (3).

In some embodiments, the switching sequence is selected so as to have higher effective sampling rates for two or more transmit settings. For example, the first and second settings (i.e., setting no. 1 and no. 2), may be selected to be equal and have a higher sampling rate than other transmit settings. This may be achieved by applying the following non-uniform switching sequence of the transmit settings:

1->2->3->1->2->4 . . . ->1->2->N->1->2>3->1 . . . ->1->2->N (9)

The sequence shown in expression (9) results in an increased sampling rate for the reflected signals associated with transmit settings 1 and 2 while causing a reduced sampling rate for the other settings 3 through N. The sampling rate for the reflected signals associated with transmit settings 1 and 2 may be obtained as shown below:

$${f}_{s , 1} = {f}_{s , 2} = \frac{1}{3 T} \qquad ( 10 )$$

The sampling rate for the reflected signals associated with transmit settings 3 through N may be obtained as shown below:

$${f}_{s , 3} = {f}_{s , 4} = … {f}_{s , N} = \frac{1}{3 ( N - 2 ) T} \qquad ( 11 )$$

Accordingly, for sequence (9), the maximum detectable Doppler frequency shift associated with transmit settings 1 and 2 is expressed as shown below:

$${f}_{d , max , 2} = {f}_{d , max , 2} = \frac{1}{6 T} \qquad ( 12 )$$

The maximum detectable Doppler frequency shift associated with transmit settings 3 through N for sequence (9) is expressed as shown below:

$${f}_{d , max , 3} = {f}_{d , max , 4} = … {f}_{d , max , N} = \frac{1}{6 ( N - 2 ) T} \qquad ( 13 )$$

Therefore, in accordance with embodiments of the present invention, the maximum detectable Doppler frequency shift for transmit settings 1 and 2 associated with sequence (9) and defined in expression (12) is greater than the maximum detectable Doppler frequency shift for transmit setting i associated with the sequence (1) and defined in expression (3).

In some embodiments, the sampling sequence/order may be randomized using a pseudo random sequence generator. Since a rigid moving object produces a single tone doppler shift, thereby causing the spectrum of the Doppler signal to be a relatively narrow band, such a randomized sequence forms a non-uniform sampling that can be used with a compressed sensing algorithm. It is understood that embodiments of the present invention include any repeating (cycle) of uniform or non-uniform switching sequence of the transmit settings that result in the same or different sampling rates as long as all the N desired transmit settings are at least applied once during each sequence cycle.

A non-uniform switching sequence of the transmit settings, in accordance with some embodiments of the present invention, provides many advantages in dynamic Doppler sensing systems. For example, the Doppler sensing system may start with a uniform switching sequence of transmit settings and then switch to a non-uniform switching sequence. After detecting a movement using the uniform switching sequence, the Doppler sensing system may adjust its switching sequence to increase the sampling rate for the reflected signal associated with one or more select settings of the uniform sequence, thereby to increase both the signal to noise ratio and the maximum detectable Doppler frequency shift for the settings.

An object moving radially towards a Doppler sensing system with speed v, generates the same Doppler frequency “blue-shift” (increase in the frequency of the reflected signal) as when it moves radially away from the system with the same speed the “red-shift” (decrease in the frequency of the reflected signal). If down-converted with a single local oscillator signal, such two movements become indistinguishable. Doppler sensing system 50 shown in FIG. 3, advantageously removes the ambiguity in determining the direction of movement.

A receiver disposed in a Doppler sensing system, in accordance with another embodiment of the present invention, has a single output supplying down-converted I and Q signals using an LO that alternates between generating in-phase and quadrature-phase signals. This may be achieved by interleaving between the down-conversion time intervals of the in-phase and quadrature-phase LO signals.

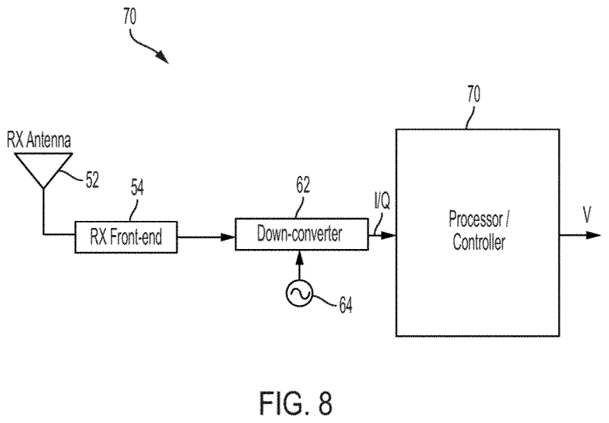

FIG. 8 is a simplified high-level schematic block diagram of a receiver 75 disposed in Doppler sensing system 10 (shown FIGS. 2A-2B), in accordance with one embodiment of the present invention. As described below, receiver 75 generates interleaved I and Q signals. Receiver 75 is shown as including, in part, a receive antenna 52, a receive front-end 54, a frequency downconverter 62, an LO 64, and a processor/controller 70. The signal received by receive antenna 52 is processed by receiver front-end 54 and delivered to down-converter 62. Frequency down-converter 62 down-converts the frequency of the signal it receives from the receiver front end using LO signal 64 to generate an in-phase (I) signal and a quadrature phase (Q) signal at the same output terminal. Signals I and Q are delivered to processor/controller 70, which in response, generates signal V which contain information about the speed and the direction of the travel of an object. Signal LO switches its phase between 0° and 90° in an alternating manner to enable the down-conversion and generation of signals I and Q in an interleaved manner. In some embodiments, instead of switching the LO phase of the receiver between 0° and 90° in an alternating manner, the phase of the transmitter is switched between 0° and 90° so that the receiver generates interleaved I and Q signals, thereby dispensing the need for switching the LO phase.

Receiver 75 may be used to generate signals I/Q using any uniform or non-uniform sequence of transmit settings. For example, in a uniform transmit setting, such as sequence (1), during the first half period T of each transmit setting, e.g., the transmit setting “1”, the LO phase is set to 0° to generate signal I for setting “1”, and during the second half period of each transmit setting the LO phase is shifted by 90° to generate signal Q for setting “1”. Similarly, for example, during the first half period of transmit setting “N”, the LO phase is set to 0° to generate signal I for setting “N”, and during the second half period of each transmit setting the LO phase is set to 90° to generate signal Q for setting “N”. It is understood that any reference herein to a 90° phase shift indicates either a +90° phase shift or a −90° phase shift.

With a uniform sequence of transmit settings, each full-cycle sequence of all transmit settings with both I and Q down-conversion would take Tₛ=2NT seconds thus resulting in an effective sampling rate of

$${f}_{s} = \frac{1}{2 NT} .$$

Using the Nyquist sampling theorem, the maximum detectable Doppler frequency shift that can be detected with no loss of information from the sampled reflected signals is described as shown below:

$${f}_{s} > 2 {f}_{d} \to {f}_{d , max} = \frac{1}{4 NT} \qquad ( 14 )$$

A Doppler sensing system, in accordance with one embodiment of the present invention, may have a multitude of transmit elements and antennas. In such embodiments, the phases of the signals transmitted by each transmit antenna varies by 90° during each pair of successive sequence cycles. For example, assume the phases of the first, second and N^{th} transmit antennas are set respectively to θ, θ+ΔØ . . . , θ+NΔØ during a first sequence cycle. In such embodiments, the phases of the first, second and N^{th} transmit antennas during the subsequent sequence cycle are set respectively to θ±90°, θ+ΔØ±90° . . . θ+NΔØ±90°.

In a non-uniform sequence, during the first half of the switching sequence the transmit settings are applied for T seconds and the reflections are captured by the single output receiver unit and down-converted using the in-phase LO signal. Once all the settings are applied, the LO phase is switched to quadrature-phase and the same switching sequence is repeated. For example, assume the transmitter uses the non-uniform sequence shown below:

1->2->1->3 (15)

When using sequence (15), the LO phase may be set to 0° for each transmit setting of the sequence transition 1->2->1->3 to generate signal I. During the subsequent sequence transition 1->2->1->3, the LO phase is shifted by 90° for each transmit setting to generate signal Q. The LO phase is then set to 0° for each transmit setting of the next sequence transition 1->2->1->3 in an alternating manner.

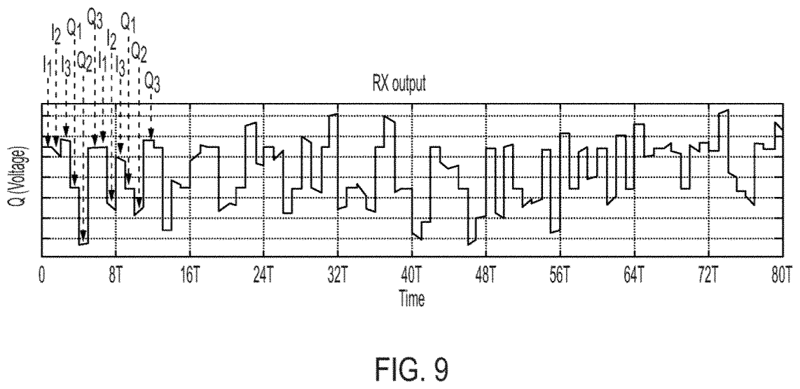

FIG. 9 shows signals I and Q of the receiver 70 (see FIG. 8) for 80 time periods associated with sequence cycle (15) for the three transmit settings resulting in the beam patterns shown in FIGS. 2A, 2B and 2C. As shown, during the first set of time periods T₁, T₂, T₃ the voltage level of signals I, namely signals I₁, I₂, I₃ respectively associated with the first, second and third transmit settings are generated. During the second set of time periods T₄, T₅, T₆ the voltage level of signal Q, namely signals Q₁, Q₂, Q₃ respectively associated with the first, second and third transmit settings are generated. During the third set of time periods T₇, T₈, T₉ the voltage level of signal I, namely signals I₁, I₂, I₃ respectively associated with the first, second and third transmit settings are generated. During the fourth set of time periods T₁₀, T₁₁ and T₁₂ the voltage level of signal Q, namely signals Q₁, Q₂, Q₃ respectively associated with the first, second and third transmit settings are generated. The sequence is shown as being repeated for 80 time periods.

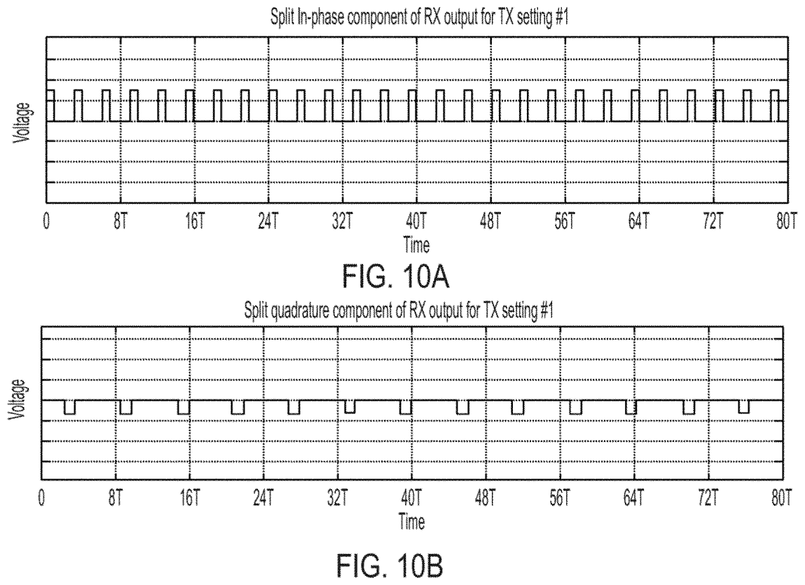

FIGS. 10A and 10B respectively show the I and Q voltages associated with and retrieved from the first transmit setting of the data shown in FIG. 9 as determined by processor/controller 70 of FIG. 8. As is seen from FIGS. 10A and 10B, since no moving object is present in the path of the beam generated in response to the first transmit setting, the corresponding I and Q signals for this setting show that there is no movement along this path, therefore the reflections from stationary objects result in DC outputs for both the I and Q signals.

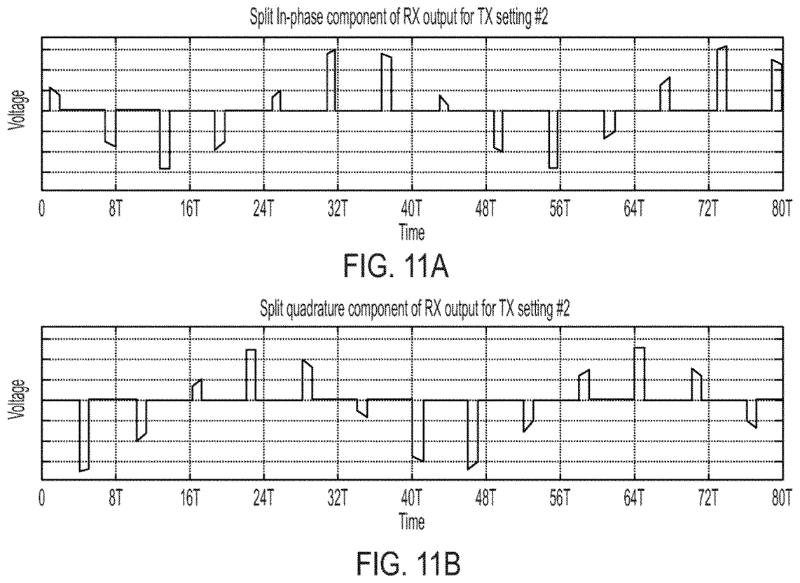

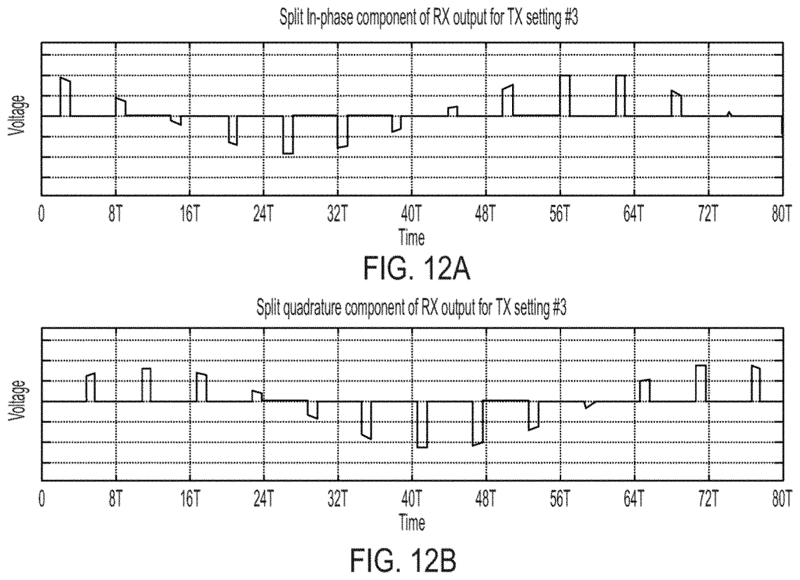

FIGS. 11A and 11B respectively show the I and Q voltages associated with and retrieved from the second transmit setting of the data shown in FIG. 9 as determined by processor/controller 70 of FIG. 8. FIGS. 12A and 12B respectively show the I and Q voltages associated with and retrieved from the third transmit setting of the data shown in FIG. 9 as determined by processor/controller 70 of FIG. 9. As seen from FIGS. 11A/11B or 12A/12B, the I/Q signals for the second and third transmit settings provide sampled sinusoidal waves with frequencies f_{d1} and f_{d2} indicative of the presence of moving objects with velocities v₁ and v₂ that are proportional to frequencies f_{d1} and f_{d2}, respectively. It is understood that embodiments of the present invention include any repeating non-uniform switching sequence of the transmit settings that result in different sampling rates as long as all the N desired transmit settings are at least applied once during each sequence cycle (i.e., each repeating sequence).

It is understood that embodiments of the present invention are equally applicable to any sequence of transmit settings. Embodiments of the present invention are equally applicable to any order of alternation between I and Q (also referred to herein as interleaving or interleaved I and Q signals) when using a receiver with a single output as long as both I and Q signals for all the transmit settings of interest are covered during each sequence cycle. It is also understood that embodiments of the present invention are equally applicable to situations where the transmitter and receiver are not collocated or when multiple transmitters or receivers may be used concurrently.

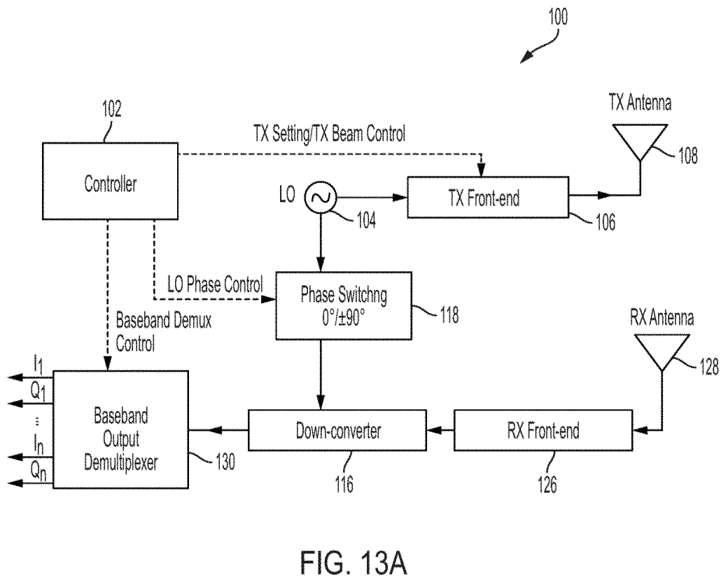

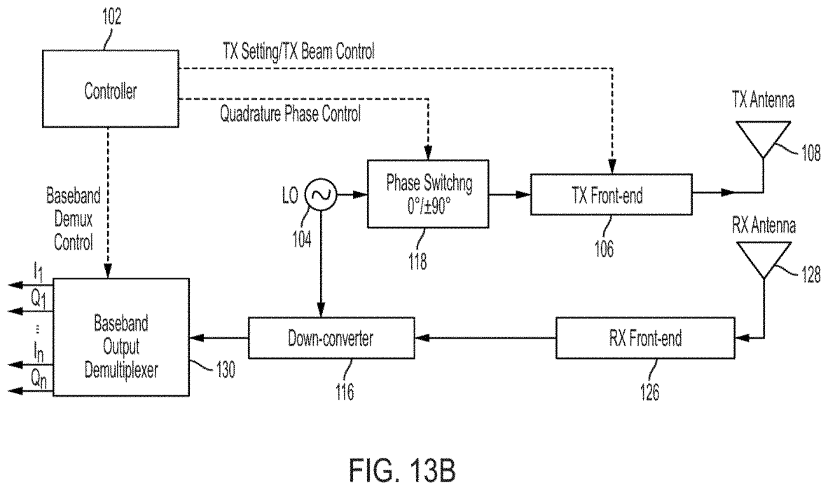

FIG. 13A is a simplified high-level block diagram of a transmitter/receiver 100 adapted to rapidly switch between transmit settings to provide Doppler sensing and further to wirelessly power a device, in accordance with one embodiment of the present invention. Transmitter/receiver 100 is shown as including, in part, a transmit antenna 108, a transmit front-end 106, an LO 104, a controller 102, a receive antenna 128, a receive front-end 126, a down-converter 116, a baseband output demultiplexer 130, and an LO phase switching circuit 118 adapted to change the phase of the signal applied to down-converter 116. Transmit front-end circuit 106 is adapted, among other things, to change the phase of the signal transmitted by antenna 108 in response to the control signal it receives from controller 102. The phase of the signal transmitted by antenna 108 is set relative to the phase of the LO signal 104.

Receive front-end 126 is adapted, among other things, to amplify the signal received by antenna 128, and deliver the amplified signal to down-converter 116. In response, down-converter 116 generates down-converted I and Q signals either individually (e.g., as shown in FIG. 3) or in an interleaved form (e.g., as shown in FIG. 8) using the LO signal supplied by phase switching circuit 118. Baseband output demultiplexer supplies the I and Q signals for each transmit settings in response to the demux control signal supplied by controller 102. Although transmitter/receiver 100 is shown as including one transmit antenna, it is understood that a transmitter/receiver in accordance with embodiments of the present invention may have a multitude of antennas each having an associated transmit element for setting the phase of that antenna. The transmit antennas may be arranged along one, two or three dimensional arrays. Similarly, although transmitter/receiver 100 is shown as including one receive antenna, it is understood that a transmitter/receiver in accordance with embodiments of the present invention may have a multitude of receive antennas. The multitude of transmit and/or receive antennas may thus form a phased array 100 adapted to perform Doppler sensing.

FIG. 13B is a simplified high-level block diagram of a transmitter/receiver 150 adapted to rapidly switch between transmit settings to provide Doppler sensing and further to wirelessly power a device, in accordance with another embodiment of the present invention. Transmitter/receiver 150 is similar to transmitter/receiver 100 except that in transmitter/receiver 150, the phase switching of the LO signal, as generated by phase switching circuit 118, is applied to the transmit front-end 106, thereby to switch the phase of the signal transmitted by antenna 108 for each transmit setting between 0° and 90°.

Although transmitter/receiver 150 is shown as including one transmit antenna, it is understood that a transmitter/receiver in accordance with embodiments of the present invention may have a multitude of antennas each having an associated transmit element for setting the phase of that antenna. The transmit antennas may be arranged along one, two or three dimensional arrays. Similarly, although transmitter/receiver 150 is shown as including one receive antenna, it is understood that a transmitter/receiver in accordance with embodiments of the present invention may have a multitude of receive antennas. The multitude of transmit and/or receive antennas may thus form a phased array 150 adapted to perform Doppler sensing. In such embodiments, the phases of the signals transmitted by each transmit antenna of the array varies by 90° during successive sequence cycles. For example, if the phases of the first, second and N^{th} transmit antennas are set respectively to θ, θ+ΔØ . . . θ+NΔØ during a third sequence cycle, the phases of the first, second and N^{th} transmit antennas during the subsequent sequence cycle are set respectively to θ+90°, θ+ΔØ+90° . . . θ+NΔØ+90°.

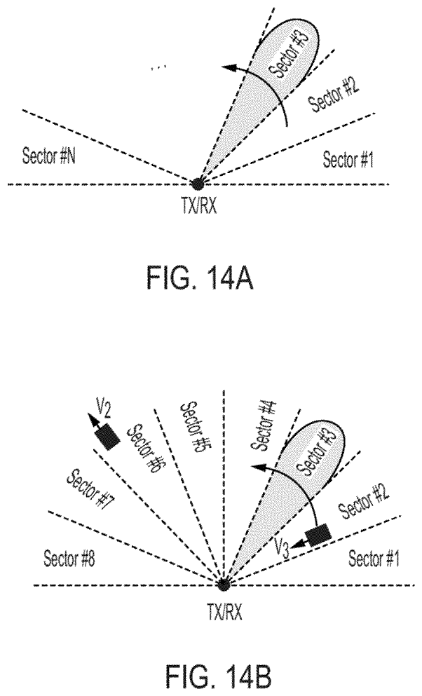

Embodiments of the present invention may also be applied to beam scanning Doppler sensing systems to increase their speed. To achieve this, the desired scanning space of the Doppler sensing system may be divided into N sectors, as shown in FIG. 14A for a one-dimensional beam scanning. Each transmit setting of the Doppler sensing system is selected so as to correspond to a beam formed towards one of the sectors. In one embodiment, there are N transmit settings each associated with a different one of the N sectors. The N transmit settings may form a uniform or a non-uniform sequence. For each transmit setting, the reflected signal is captured and down-converted to determine the Doppler frequency shift.

In such embodiments, the total scan time for one full cycle of all sectors of the desired space is Tₛ=NT, where T is the period for each transmit setting. Accordingly, during each full scan cycle, the Doppler system's receiver generates N down-converted samples of the reflected signals, each corresponding to a different one of the N scanned sectors, with each sample lasting T seconds. Therefore, by repeating this cycle, each sector is scanned continuously with the effective sampling rate of fs=1/Ts=1/(NT).

A processor/controller unit, which may be an embedded microprocessor, microcontroller, FPGA, ASIC, or otherwise, splits the receiver output into N different signals each including the samples of the down-converted reflected Doppler signals from a different sector. Using the Nyquist sampling theorem, the maximum detectable Doppler frequency shift f_{d,max} (corresponding to the maximum rate of movement of an object within each sector) with lossless recovery of the reflected Doppler signal for uniform sampling may be written as:

$${f}_{s} > 2 {f}_{d} \to {f}_{d , max} = \frac{1}{2 NT} \qquad ( 16 )$$

FIG. 14B shows an exemplary 8-sector space being sensed with a Doppler sensing system, in accordance with one embodiment of the present invention. A first object is shown as moving with speed V₁ away from the transmitter/receiver 10, and a second object is shown as moving towards transmitter/receiver 10 with speed V₂. The receiver disposed in transmitter/receiver 10 is assumed to correspond to receiver 50 shown in FIG. 3. Receiver 50 is adapted to supply down-converted signals I and Q to processor/controller 70, which in response, rearranges the received data into eight pairs of I/Q outputs to separate the Doppler signals based on the sectors from which they were received.

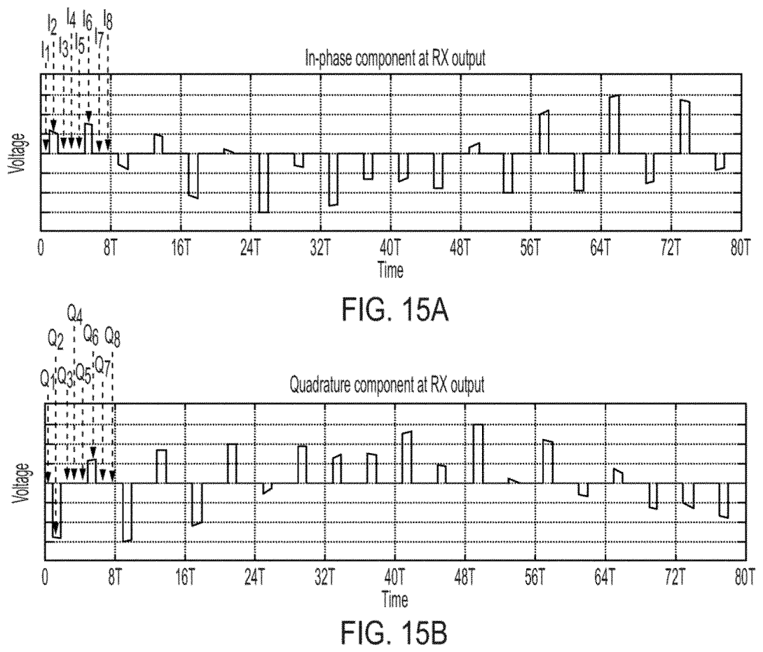

FIGS. 15A and 15B respectively show 80 periods of the I/Q signals associated with the 8 sectors shown in FIG. 14B. Signals I₁, I₂, I₃, I₄, I₅, I₆, I₇, I₈ of FIG. 15A, obtained during periods T₁, T₂, T₃, T₄, T₃, T₆, T₇, T₈, are the in-phase signals associated with sectors 1, 2, 3, 4, 5, 6, 7, 8. Similarly, signals Q₁, Q₂, Q₃, Q₄, Q₅, Q₆, Q₇, Q₈ of FIG. 15B, obtained during periods T₁, T₂, T₃, T₄, T₅, T₆, T₇, T₈, are the quadrature-phase signals associated with sectors 1, 2, 3, 4, 5, 6, 7, 8. Signals I and Q₂ of FIGS. 15A and 15B represent data corresponding to the movement of the object in sectors No. 2. Similarly, signals I₆ and Q₆ of FIGS. 15A and 15B represent data corresponding to the movement of the object in sectors No. 6. As seen from FIGS. 15A and 15B, no movement in any other sectors is sensed.

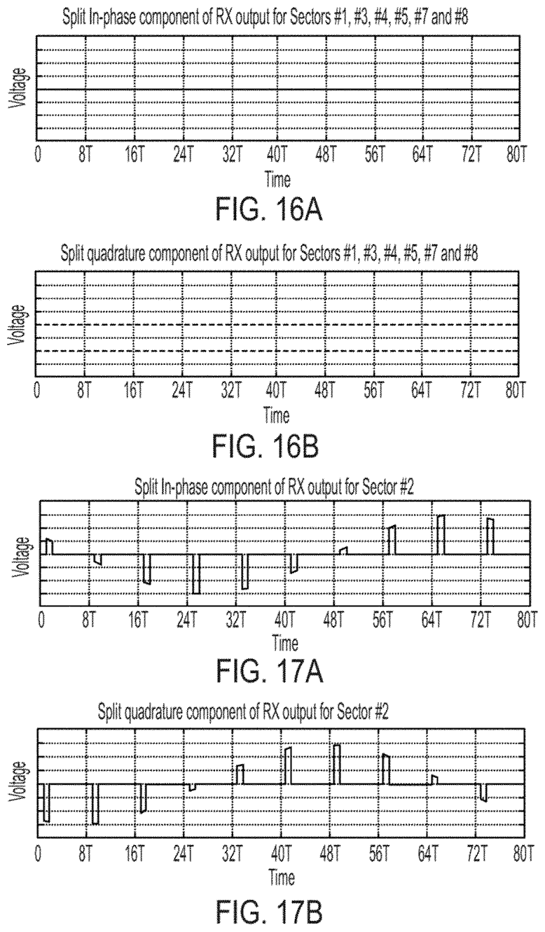

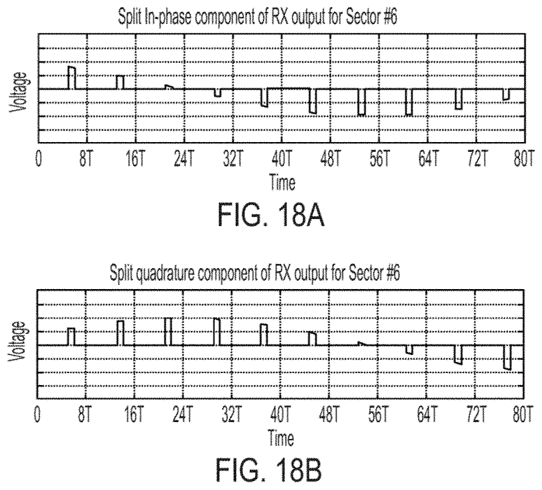

FIGS. 16A and 16B shows the I and Q signals associated with sectors 1, 3, 4, 5, 7 and 8 as obtained and processed by processor 70 from the data shown in FIGS. 15A and 15B. FIGS. 16A and 16B show the absence of movement in sectors 1-2, 3-5 and 7-8. FIGS. 17A and 17B shows the I and Q signals associated with the movement of the object in sector number 2 as obtained and processed by processor 70 from the data shown in FIGS. 15A and 15B. FIGS. 18A and 18B shows the I and Q signals associated with the movement of the object in sector number 6 as obtained and processed by processor 70 from the data shown in FIGS. 15A and 15B.

Embodiments of the present invention may also be applied to two-dimensional beam scanning Doppler sensing systems by similarly dividing the two-dimensional scan space into N sectors and scanning each sector. It is understood that the switching between the different sectors may be performed using either a uniform or a non-uniform switching sequence as described in detail above. The I and Q signals may be obtained using a receiver with at least two output terminals (such as that shown in FIG. 3) with one terminal supplying the I signal and the other supplying the Q signal. Alternatively, the I and Q signals may be obtained using a receiver having a terminal which supplies both the I and Q signals in an interleaved manner, such as the receiver shown in FIG. 8 and described above. Embodiments of the present invention also apply to situation in which the transmitter and receiver are not collocated or when multiple transmitters or receivers are used concurrently.

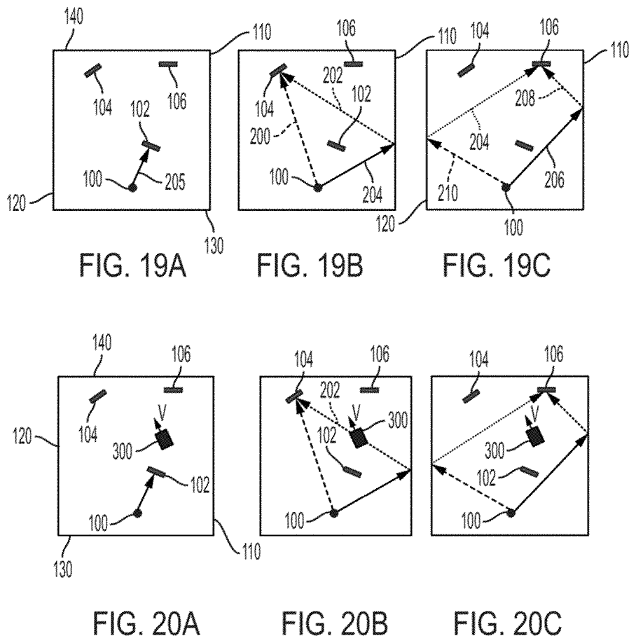

A switching Doppler sensing system and method, in accordance with embodiments of the present invention, may also be used in wireless power transfer systems in which a power Generation Unit (GU) transfers power wirelessly to one or more power Recovery Units (RU). FIG. 19A shows three RUs, namely 102, 104 and 106 that are positioned away from GU 100 in a reflective environment enclosed within walls 110, 120, 130 and 140. In FIG. 19A, the transmitter disposed in GU 100 is set to a first setting so as to deliver the beam along direction 205 to RU 102. In FIG. 19B, the transmitter disposed in GU 100 is set to a second setting so as to deliver the beam along direction 200 to RU 102. In addition, the transmitter also delivers a beam along direction 204 which after being reflected off wall 110 is received by RU 104 along direction 202. Therefore, in FIG. 19B, the transmitter includes a multitude of transmitting elements and antennas a subset of which are set to generate and direct a beam along direction 200 and a second subset of which are set to generate and direct a beam along direction 200. In FIG. 19C, the transmitter disposed in GU 100 is set to a third setting so as to deliver beams along directions 206 and 210. The beam travelling along direction 210 is reflected off wall 120 and travels along direction 204 before being received by RU 106. The beam travelling along direction 206 is reflected off wall 110 and travels along direction 208 before being received by RU 106.

In addition to power generation, GU 100 also includes a Doppler sensing receiver. In order to transfer power to RUs 102, 104, 106, the settings of the transmitter disposed in GU 100 are rapidly switched between the three settings describe above so as to maximize the power delivery to each RU. Therefore the GU effectively transfers power to all three RUs at nearly the same time.

For regulatory compliance and maximum exposure control. GU 100 may need to reduce its power level or shut down its output directed along a path if there is a human or animal detected along that path. FIGS. 20A, 20B and 20C are similar to FIGS. 19A, 19B and 19C respectively except that in FIGS. 20A, 20B and 20C a moving object 300 is also shown within the confines of walls 110, 120, 130 and 140. In FIG. 20A, object 300 does not block the path from GU 100 to RU 102. Similarly, in FIG. 20C, object 300 does not block the paths from GU 100 to RU 106. In FIG. 20B, however, object 300 is shown as blocking the power being delivered along direction 202.

The receiver unit disposed in GU 100 is adapted to continuously receive the reflected signals as the GU rapidly switches between the three transmit settings that result in the beam patterns shown in FIGS. 20A, 20B and 20C. Because moving object 300 is on the transmit path of RU 202, the receiver unit of GU 100 detects this movement, as described above, thereby causing the transmitter of the GU to adjust its setting and timing such that the power it transmits does not exceed the prespecified power levels.

GU 100 is adapted to make the adjustment while continuing to transfer power to RU 102 and 106 using the first and third transmit settings of a uniform or non-uniform sequence without interruption. The I and Q signals may be supplied by a receiver with at least two output terminals (such as that shown in FIG. 3) with one terminal supplying the I signal and the other supplying the Q signal. Alternatively, the I and Q signals may be supplied using a receiver having a terminal which supplies both the I and Q signals in an interleaved manner, such as the receiver shown in FIG. 8 and described above. Embodiments of the present invention also apply to situations in which the transmitter and receiver are not collocated or when it includes multiple transmitters and/or receivers that operate concurrently.

In some embodiments, the GU may be configured not to capture Doppler signals during power transfer. Alternatively, the GU may be configured to detect movements at locations that are not in the path of the wireless power transfer. To accommodate such conditions, the switching sequence of the transmit settings may include a first set of transmit settings with a relatively high power for power transfer to one or more RUs as well as a second set of transmit settings with relatively lower power to scan other locations and directions to detect moving objects. In other words, the switching sequence of the transmitter, in accordance with some embodiments of the present invention, may include interleaved power transfer intervals and Doppler sensing intervals.

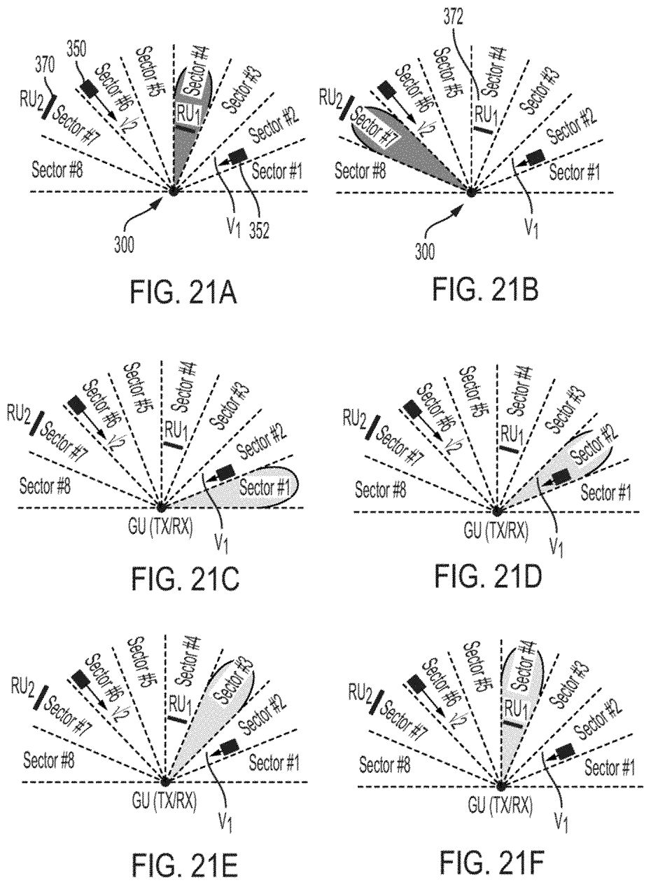

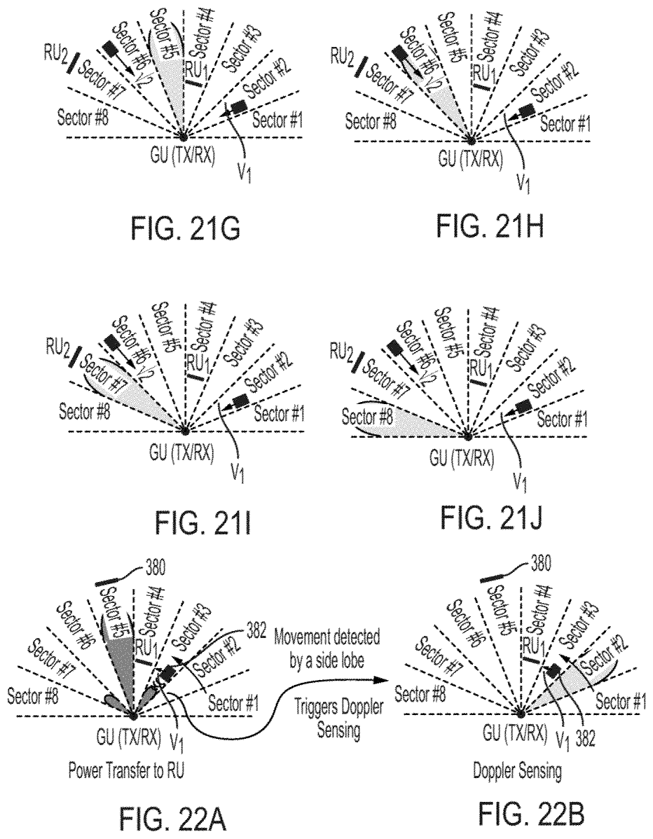

FIGS. 21A-21J show a GU 300 that switches its transmit settings to one of two power transfer modes and one of 8 sensing modes (i.e., a total of 10 modes) during different times. GU 300 is thus adapted to transfer power to RUs 370 and 372 positioned in sectors 7 and 4 using two transmit settings, while also performing a scan of the space that is divided into eight sectors using 8 other transmit settings to detect possible presence of humans or other moving objects. Object 352 is shown as moving toward GU 300 in sector 2, and object 370 is shown as moving toward GU 300 in sector 6. Both uniform as well as non-uniform switching between transmit settings as well as separate or interleaved I/Q signals may be used.

Assume that the transmit settings during power transfer modes are denoted as PT₁ and PT₂. Assume further that the transmit settings during sensing modes are denoted as DS₁, DS₂, DS₃, DS₄, DS₅, DS₆, DS₇, and DS₈. One exemplary sequence that may be used to switch between power transfer mode and sensing mode is shown below:

PT₁→PT₂→PT₁→PT₂→PT₁→PT₂→PT₁→DS₁→PT₂→DS₂→PT₁→DS₃→PT₂→DS₄→PT₁→DS₅→PT₂→DS₆→PT₁→DS₇→PT₂→PT₂→DS₈→PT₂→PT₂→PT₂ . . . (17)

The radiation pattern of GU generally includes additional side lobes with significantly lower power compared to the main radiation lobe. Therefore, a movement in the path of the side lobes may also be detected by a Doppler receiver of the GU. Therefore, in accordance with some embodiments of the present invention, the GU is adapted to continue to transfer power to the RUs while concurrently detecting movements by the Doppler receiver disposed in the GU along the main power transfer path as well as the paths of the sidelobes caused by reflection. If the GU Doppler receiver detects a movement using the information included in the sidelobes, the GU may then switch to a Doppler scanning mode, such as those shown in FIGS. 21C-21U, to switch between the different transmit settings of the scanning mode to more accurately locate the movement of the object and predict its path, thereby avoiding potential exposure to excessive power levels in the event the moving object is a human, pet, or another living organism.

FIG. 22A shows a GU 300 adapted to transfer power and detect/sense movements in a space divided into 8 equal sectors. An RU 380 is shown as being positioned in sector number 5, and an object 382 is shown as moving in sector number 3. While in the power transfer mode, GU 300 detects objects 382 using the sidelobes of the radiation that GU delivers to sector No. 3. Immediately after this detection, GU 300 switches to scanning mode, as shown in FIG. 22B to more accurately determine the speed and direction of movement of object 382.

A fast-switching Doppler sensing system and method, in accordance with embodiments of the present invention, are equally applicable to communication systems. Assume during communication between two devices, at least one of the devices is moving with respect to the other one. Assume further that a Doppler transmitter and receiver, in accordance with some embodiments of the present invention, is included in at least one of the devices. Accordingly, the communication intervals (the time periods during which communication is taking place) between the two devices may be interleaved with Doppler sensing intervals (the time periods during which Doppler sensing is taking place) to enable the movement detection, and thereby determine the direction of the movement so as to maintain wireless connectivity between the two devices. Embodiments of the present invention may also be used in line-of-sight communication systems (for both mobile and stationary devices) to detect the movement of the objects that may block the line of sight.

The above embodiments of the present invention are illustrative and not limitative. The above embodiments of the present invention are not limited by the number of GUs, RUs, transmitters, receivers, antennas or the moving objects. Embodiments of the present invention are not limited by the type of sequence, non-uniform or otherwise that may be used for transmit setting. Embodiments of the present invention are not limited by the type of receiver disposed in the GU. Other additions, subtractions or modifications are obvious in view of the present disclosure and are intended to fall within the scope of the appended claims.

What is claimed is:

1. A Doppler sensing system comprising:
at least one transmit antenna;
a processor configured to cause the transmit antenna to transmit signals during M repeating cycles of a sequence, wherein for each cycle the transmit antenna is set to N different transmit settings each during a different one of N time periods to generate N different signals; and
a receiver configured to receive reflections of the signals generated by the transmit antenna.

2. The Doppler sensing system of claim 1 wherein said sequence is a uniform sequence.

3. The Doppler sensing system of claim 1 wherein said sequence is a non-uniform sequence.

4. The Doppler sensing system of claim 1 wherein a signal transmitted during cycle i of the sequence is received by the receiver during cycle i of the sequence.

5. The Doppler sensing system of claim 1 wherein the N time periods are substantially similar.

6. The Doppler sensing system of claim 1 wherein at least one of the N time periods is different than a remaining ones of the time periods.

7. The Doppler sensing system of claim 1 wherein the transmitter is set at least twice to at least one of the N settings during each cycle.

8. The Doppler sensing system of claim 1 wherein said receiver comprises a first frequency downconverter adapted to generate in-phase (I) signals and a second frequency downconverter adapted to generate quadrature-phase (Q) signals.

9. The Doppler sensing system of claim 8 wherein the processor is further configured to generate 1 and Q signals associated with each transmit setting from the signals the processor receives from the receiver.

10. The Doppler sensing system of claim 1 further comprising:
a phase switching circuit adapted to switch a phase of a local oscillator (LO) signal by 90° in responses to a phase control signal supplied by the processor, and
a frequency downconverter adapted to generate in-phase (I) and quadrature-phase (Q) signals from the signal received by the receiver and in response to the phases of the LO signal.

11. The Doppler sensing system of claim 1 further comprising:
a phase switching circuit adapted to switch a phase of a transmit signal by ±90° in responses to a phase control signal supplied by the processor, wherein said processor causes the transmitter to transmit, for each transmit setting, a first signal defined by a first phase, and a second signal defined by a second phase.

12. The Doppler sensing system of claim 1 wherein said sequence comprises uniform and non-uniform cycles.

13. The Doppler sensing system of claim 1 wherein said processor causes the Doppler sensing system to transfer power wirelessly during at least one of the N periods.

14. A method of determining a frequency shift of a signal reflected by a moving object, the method comprising:
transmitting signals during M repeating cycles of a sequence, wherein for each cycle a transmit antenna is set to N different transmit settings during each of N different time periods to generate N different signals; and
receiving reflections of the signals generated by the transmit antenna to determine the frequency shift.

15. The method of claim 14 wherein said sequence is a uniform sequence.

16. The method of claim 14 wherein said sequence is a non-uniform sequence.

17. The method of claim 14 further comprising:
receiving, during cycle i of the sequence, a signal transmitted during cycle i of the sequence.

18. The method of claim 14 wherein the N time periods are substantially similar.

19. The method of claim 14 wherein at least one of the N time periods is different than a remaining ones of the time periods.

20. The method of claim 14 further comprising setting the transmitter at least twice to at least one of the N settings during each cycle.

21. The method of claim 14 further comprising:
down-converting a frequency of the received signal to generate an in-phase (I) signal using a first frequency down-converter; and
down-converting a frequency of the received signal to generate a quadrature-phase (Q) signal using a second frequency down-converter.

22. The method of claim 14 further comprising:
down-converting a frequency of the received signal to generate in-phase (I) and quadrature-phase (Q) signals using a frequency down-converter.

23. The method of claim 14 further comprising:
switching a phase of a local oscillator (LO) signal by 90° in responses to a phase control signal supplied by a processor; and
generating in-phase (I) and quadrature-phase (Q) signals from the received signal in response to the phases of the LO signal.

24. The method of claim 14 further comprising:
switching a phase of a transmit signal by ±90° in responses to a phase control signal supplied by a processor; and
transmitting, for each transmit setting, a first signal defined by a first phase and a second signal defined by a second phase.

25. The method of claim 14 wherein said sequence comprises uniform and non-uniform cycles.

26. The method of claim 14 further comprising:
transferring power by the transmitter wirelessly during at least one of the N periods.
